(19) United States
(12) Patent Application Publication
(10) Pub. No.: US 2026/0058764 A1
(43) Pub. Date: Feb. 26, 2026

(54) METHODS AND SYSTEMS FOR GENERATING OTFDM WAVEFORMS USING AN INPUT BIT SEQUENCE

(71) Applicant: WISIG NETWORKS PRIVATE LIMITED, Madinaguda, Hyderabad (IN)

(72) Inventors: Koteswara Rao Gudimitla, Srikalahasti (IN); Sibgath Ali Khan Makandar, Hyderabad (IN); Kiran Kumar Kuchi, Madinaguda, Hyderabad (IN); Saidhiraj Amuru, Manikonda, Hyderabad (IN); Sakshama Gholsya, Jaipur (IN)

(21) Appl. No.: 19/102,519

(22) PCT Filed: Sep. 15, 2023
(86) PCT No.: PCT/IN2023/050864

§ 371 Date: Feb. 10, 2025

(30) Foreign Application Priority Data
Sep. 15, 2022 (IN) 202241052843

(51) Int. Cl. H04L 5/00; H04L 27/26

(52) U.S. Cl. CPC H04L 5/0007; H04L 5/0055; H04L 27/2628

(57) ABSTRACT

Embodiments of the present disclosure relate to a method for transmitting a waveform. The method comprising generating, by a transmitter, an orthogonal time frequency division multiplexing (OTFDM) waveform corresponding to an input bit sequence, wherein said input bit sequence is uniquely mapped to one of the plurality of OTFDM waveforms. Also, the method comprises transmitting the OTFDM waveform corresponding to the input bit sequence. Embodiments of the present disclosure also relates to method of receiving OTFDM waveforms.

### CROSS-REFERENCE TO RELATED APPLICATIONS

This application claims priority from the Indian Provisional Patent Application No. 202241052843 filed on Sep. 15, 2022, the entirety of which are hereby incorporated by reference.

### TECHNICAL FIELD

Embodiments of the present disclosure are related, in general to communication, but exclusively relate to methods and systems for generating and transmitting orthogonal time frequency division multiplexing (OTFDM) waveforms using input bit sequence.

### BACKGROUND

3GPP (3rd Generation Partnership Project) has developed 5G-NR standards to support use cases like eMBB, URLLC, MMTC. It has been agreed to use CP-OFDM waveform and DFT-s-OFDM waveform for uplink transmission in 5G-NR. Here, CP-OFDM is mainly used for higher data rates, while, because of its low PAPR and high-power efficiency, DFT-s-OFDM is used to serve the cell edge UEs. Current 5G standards uses slot structure, where user data is transmitted in series of OFDM symbols. A typical slot structure comprises of one or more data symbols and one or more reference symbols.

6G Mobile Communication System requires a method of information transmission and that offers extremely low latency, very high data rate, and very high-power efficiency. DFT-S-OFDM waveform, which is power efficient and supports high data rates is well suitable for this purpose. However, to achieve very high power efficiency, a new waveform is desirable, especially in transmission of sequence based control data transmission, where, a modulated sequence is selected to transmit either a 1-bit, 2-bit or control information transmission using small number of bits.

6G system is required to support a low PAPR waveform that not only has low PAPR but also enables reliable control channel decoding at high interference levels and the waveform should allow support multiple users using the available time-frequency resources simultaneously.

In addition, 6G Systems require a waveform that can be used for sensing purposes along with communications. The waveform used for sensing should have low PAPR. Therefore, a low-PAPR waveform that enables integrated sensing and communications is required.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for transmitting a waveform is disclosed. The method comprising generating, by a transmitter, an orthogonal time frequency division multiplexing (OTFDM) waveform corresponding to an input bit sequence, wherein said input bit sequence is uniquely mapped to one of the plurality of OTFDM waveforms. Also, the method comprises transmitting, by the transmitter, the OTFDM waveform corresponding to the input bit sequence.

In another aspect of the present disclosure a for transmitting a plurality of waveforms is disclosed. The method comprises generating, by plurality of transmitters, an orthogonal time frequency division multiplexing (OTFDM) waveform corresponding to an input bit sequence associated with one of a plurality of transmitters, wherein an input bit sequence of each of the plurality of transmitters is uniquely mapped to one of a plurality of OTFDM waveforms. Also, the method comprises transmitting, by the plurality of transmitters, the OTFDM waveform corresponding to the input bit sequence associated with each of the plurality of transmitters.

In yet another aspect of the present disclosure a method for receiving a waveform is provided. The method comprising performing, by the receiver, a Fast Fourier Transform (FFT) on a received waveform to obtain a transformed sequence. Also, the method comprises performing de-mapping operation on the transformed sequence using a plurality of sub-carriers to generate a de-mapped sequence. Further, the method comprises performing correlation operation on the de-mapped sequence using a plurality of sequences to obtain a correlation value and comparing the correlation value using a threshold to obtain best matched sequence. Furthermore, the method comprises demodulating the best matched sequence to obtain transmitted bit sequence.

In yet another aspect of the present disclosure a method for receiving a waveform is provided. The method comprising performing, by the receiver, a Fast Fourier Transform (FFT) on a received waveform to obtain a transformed sequence. Also, the method comprises performing de-mapping operation on the transformed sequence using a plurality of sub-carriers to generate a de-mapped sequence. Further, the method comprises filtering and spectrum folding the de-mapped sequence to obtain a filtered, spectrum folded de-mapped sequence. Furthermore, the method comprises performing correlation operation on the de-mapped sequence using a plurality of sequences to obtain a correlation value, and comparing the correlation value using a threshold to obtain best matched sequence. Thereafter, the method comprises demodulating the best matched sequence to obtain transmitted bit sequence.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1A shows a block diagram of an OTFDM transmitter, in accordance with an exemplary embodiment of the present disclosure;

FIG. 1B shows a block diagram of an OTFDM symbol generating unit, in accordance with an embodiment of the present disclosure;

FIG. 1C shows a block diagram of a processing unit of the OTFDM symbol generating unit as shown in FIG. 1B, in accordance with an embodiment of the present disclosure;

FIG. 2A shows a block diagram illustrating sequence mapping for an input bit sequence and generation of OTFDM waveform;

FIG. 2B shows a representation of the plurality of transmitters occupying distinct bandwidths in a given resource grid;

FIG. 3 shows Frequency response of 2-tap filter obtained from over sampling of LGMSK pulse;

FIG. 4 shows Frequency response of raised cosine pulse;

FIG. 5 shows Frequency response of square root raised cosine pulse;

FIG. 6 shows Frequency response of square root of 2-tap filter obtained from over sampling of LGMSK pulse;

FIG. 7 shows Frequency response of square root of raised cosine pulse;

FIG. 8 shows Frequency response of square root of square root raised cosine pulse;

FIG. 9A shows a flowchart illustrating a method for transmitting a waveform in a communication network, in accordance with some embodiments of the present disclosure.

FIG. 9B shows a flowchart illustrating a method for transmitting a waveform in a communication network, in accordance with another embodiments of the present disclosure.

FIG. 10A shows a block diagram of a receiver, in accordance with an embodiment of the present disclosure;

FIG. 10B shows a block diagram of a receiver, in accordance with another embodiment of the present disclosure;

FIG. 11 an illustration of obtaining L samples from L+d samples;

FIG. 12A shows a flowchart illustrating a method for receiving a waveform in a communication network, in accordance with some embodiments of the present disclosure; and

FIG. 12B shows a flowchart illustrating a method for receiving a waveform in a communication network, in accordance with another embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Embodiments of the present disclosure relate to a method for transmitting a waveform. The method comprising generating, by a transmitter, an orthogonal time frequency division multiplexing (OTFDM) waveform corresponding to an input bit sequence, wherein said input bit sequence is uniquely mapped to one of the plurality of OTFDM waveforms. Also, the method comprises transmitting, by the transmitter, the OTFDM waveform corresponding to the input bit sequence.

Another embodiment of the present disclosure is related to a method for transmitting a waveform. The method comprising generating, by plurality of transmitters, an orthogonal time frequency division multiplexing (OTFDM) waveform corresponding to an input bit sequence associated with one of a plurality of transmitters, wherein an input bit sequence of each of the plurality of transmitters is uniquely mapped to one of a plurality of OTFDM waveforms. Also, the method comprises transmitting, by the plurality of transmitters, the OTFDM waveform corresponding to the input bit sequence associated with each of the plurality of transmitters.

Also, embodiments of the present disclosure relate to a method for receiving a waveform. The method comprising performing, by the receiver, a Fast Fourier Transform (FFT) on a received waveform to obtain a transformed sequence. Also, the method comprises performing de-mapping operation on the transformed sequence using a plurality of sub-carriers to generate a de-mapped sequence. Further, the method comprises performing correlation operation on the de-mapped sequence using a plurality of sequences to obtain a correlation value and comparing the correlation value using a threshold to obtain best matched sequence. Furthermore, the method comprises demodulating the best matched sequence to obtain transmitted bit sequence.

Another embodiment of the present disclosure is related to a method for receiving a waveform. The method comprising performing, by the receiver, a Fast Fourier Transform (FFT) on a received waveform to obtain a transformed sequence. Also, the method comprises performing de-mapping operation on the transformed sequence using a plurality of sub-carriers to generate a de-mapped sequence. Further, the method comprises filtering and spectrum folding the de-mapped sequence to obtain a filtered, spectrum folded de-mapped sequence. Furthermore, the method comprises performing correlation operation on the de-mapped sequence using a plurality of sequences to obtain a correlation value, and comparing the correlation value using a threshold to obtain best matched sequence. Thereafter, the method comprises demodulating the best matched sequence to obtain transmitted bit sequence.

The present disclosure provides a waveform technology that not only addresses this critical issue of reducing PAPR, improving user multiplexing ability through spreading, improving energy efficiency but also achieves one of the major goals of future wireless communication systems i.e., extremely low latency.

One possible method to meet this requirement of high-power efficiency in transmitting a modulated sequence is to use DFT-S-OFDM with spectrum shaping that helps in reducing the PAPR of the waveform, eventually resulting in better power efficiency. However, this method is proven to be work only for sequences like pi/2-BPSK and not for other modulation schemes or sequences like ZC, or M-ary PSK.

The aforementioned issue is circumvented by expanding the bandwidth i.e. by using additional subcarriers, of the DFT precoded sequence followed by shaping the spectrum by a pulse shaping filter such as raised cosine or square-root-raised-cosine pulse or filters that follows Nyquist criterion for zero ISI (when the receiver has no timing error). This method is referred to as “Orthogonal Time Frequency Division Multiplexing (OTFDM)/Pre DFT sequence modulated DFT-S-OFDM with excess bandwidth shaping”. The design parameters include, but not limited to length of sequence, the excess BW and the DFT size can be selected carefully to minimize the PAPR.

One embodiment of the present disclosure is a transmitter. The transmitter is configured to transmit either a one or more bits of control/user data, referred as input bit sequence, the input bit sequence is mapped to one of the sequence from a plurality of L-length sequences. The input bit sequence is one of Acknowledgement (ACK), Negative-Acknowledgement (NACK), and Scheduling Request (SR). The length of the sequence, L is multiple of 6 i.e., 6, 12, 18, 24, and so on. The value L can be any arbitrary natural number. These plurality of sequences is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence. If the sequence is pi/2-BPSK sequences, phase continuity across the modulated symbols is maintained for better PAPR. The mapped sequence can be represented by x′ (n), where n=0, 1, . . . , L−1. L is length of the sequence, which can be a multiple of 6. The mapped sequence is fed to OTFDM waveform generating unit to generate OTFDM waveform.

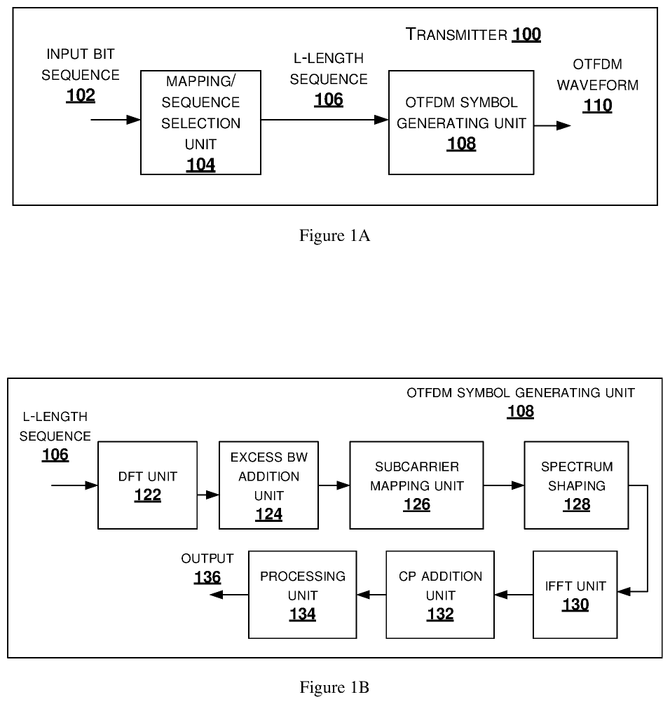

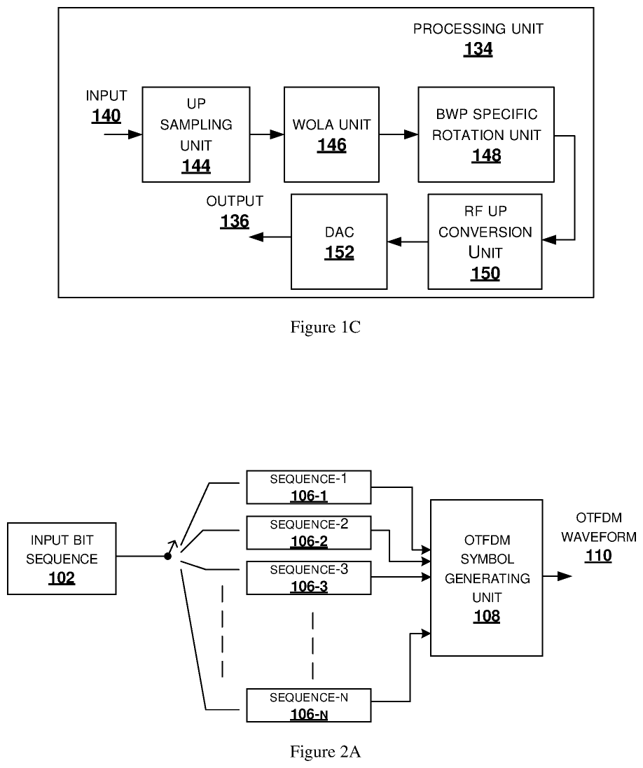

FIG. 1A shows a block diagram of an orthogonal time frequency division multiplexing (OTFDM) transmitter, in accordance with an exemplary embodiment of the present disclosure. The OTFDM transmitter is referred to as a transmitter or a communication system. The OTFDM transmitter 100 comprises a processor and memory coupled with the processor (not shown in the figure). The processor may be configured to perform one or more functions of the communication system to generate waveform based on an input bit sequence and transmit the generated waveform to a receiver. In one implementation, the communication system may comprise units or blocks or modules for performing various operations in accordance with the embodiments of the present disclosure.

As shown in the FIG. 1A, the transmitter 100 comprises a mapping unit/sequence selection unit 104, an OTFDM symbol generating unit 108 and one or more antennas (not shown in the figures) for transmitting the generated OTFDM waveform. The OTFDM symbol generating unit 108 is also referred as OTFDM symbol generator or symbol generator.

The mapping/sequence selection unit 104 performs mapping of the input bit sequence 102 to one of a L-length sequence 106 from a plurality of L-length sequences. The input bit sequence 102 comprises one or more bits. The input bit sequence is at least one of ACK. NACK and SR. The output of the sequence selection unit 104 is referred to as mapped sequence or mapped L-length sequence or L-length sequence 106. In an embodiment, the L-length sequence is a complex sequence. Each of the plurality of L-length sequences is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence. The value of L is one of 6, 12, 24, 36, 48 or any other value. In an embodiment, the L-length sequence is selected based on at least one of a scrambling ID, symbol ID, slot number, and cell ID.

The OTFDM symbol generating unit 108 generates an output called as OTFDM waveform 110, also referred as an OTFDM symbol, using the mapped L-length sequence. In an embodiment, when the transmitter 100 comprises one or more antennas, the L-length sequence is fed to the OTFDM generating unit 108, to generate a OTFDM waveform or symbol specific to a particular antenna port or beam. The waveform generated is transmitted by one of a specific antenna port from the one or more antenna ports.

FIG. 1B shows a block diagram of an OTFDM symbol generating unit, in accordance with an embodiment of the present disclosure. As shown in the FIG. 1B, the OTFDM symbol generating unit 108 comprises a Discrete Fourier Transform (DFT) unit 122, an excess BW addition unit 124, a sub-carrier mapping unit 126, a spectrum shaping unit 128, an inverse Fast Fourier transform (IFFT) unit 130, a cyclic prefix (CP) addition unit 132 and a processing unit 134.

The DFT unit 122 transforms an input L-length sequence 106 using a Discrete Fourier Transform (DFT) to generate a transformed sequence.

The excess BW addition unit 124 performs padding operation on the transformed multiplexed sequence i.e. prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero. The values of N1 and N2 may be same or different. The value of N1 and N2 may depend on the excess power that is sent by the transmitter. The value of N1 and N2 depends on one of channel conditions, modulation order, coding rate, impulse response of spectrum shaping filter.

The sub carrier mapping unit 126, also referred as a mapper or a sub carrier mapper or a mapping unit, performs subcarrier mapping on the extended bandwidth transformed sequence with at least one of localized and distributed subcarriers to generate a subcarrier mapped sequence or subcarrier mapped extended bandwidth transformed sequence. In an embodiment, the distributed subcarrier mapping includes insertion of zeros in to the subcarrier mapped sequence. In an embodiment, the location of the subcarriers that are mapped to available subcarriers is specific to the transmitter or antenna port or beam or user.

In an embodiment, a length of the excess subcarriers added to the transformed sequence is explicitly indicated by one of a transmitter to a receiver and a receiver to a transmitter. The explicit indication is one of a function of allocation to the receiver and a plurality of predefined values at the transmitter.

In an embodiment, length of the excess subcarriers added to the transformed sequence is explicitly indicated by a transmitter to a receiver, wherein said explicit indication is one of a function of number of subcarrier allocation and a plurality of predefined values at the transmitter and power capability of the transmitter.

The spectrum shaping unit 126, also referred as a shaping unit or a filter or spectrum shaping with excess BW unit, performs shaping of the subcarrier mapped sequence to obtain a shaped subcarrier mapped sequence or shaped sequence. The filter used for the shaping operation on the subcarrier mapped sequence is one of a Nyquist filter, square root raised cosine filter, a raised cosine filter, a hamming filter, a Hanning filter, a Kaiser filter, an oversampled GMSK filter and any filter that satisfies predefined spectrum characteristics.

The IFFT unit 130 performs inverse IFFT on the shaped subcarrier mapped sequence to produce a time domain sequence. The CP addition unit 132 performs an addition of symbol cyclic prefix on the time domain sequence to generate time domain sequence with CP, which is processed by the processing unit 134 to generate an output 136 i.e. an OTFDM waveform or symbol.

FIG. 1C shows a block diagram of the processing unit 134 of the OTFDM symbol generating unit 108 as shown in FIG. 1B, in accordance with an exemplary embodiment of the present disclosure. As shown in FIG. 1C, the processing unit 134 comprises an up sampling unit 144, a weighted with overlap and add operation (WOLA) unit 146, a bandwidth parts (BWP) specific rotation unit 148, a RF up-conversion unit 150, and a digital to analog converter (DAC) 152. In an embodiment, the processing unit 134 may not comprise of the WOLA and the BWP rotation operations.

The processing unit 134 processes the time domain sequence with CP to generate an OTFDM waveform or OTFDM symbol. The processing comprises performing at least one of a symbol specific phase compensation, up sampling using the up-sampling unit 144, addition of symbol cyclic suffix, windowing, weighted with overlap and add operation (WOLA) using the WOLA unit 146, bandwidth parts (BWP) rotation using BWP specific rotation unit 148, an additional time domain filtering, sampling rate conversion to match DAC rate, frequency shifting on the time domain waveform using RF up conversion unit 150 and converting the same into analog using the DAC 152, to generate the output OTFDM symbol or OTFDM waveform 136. The generated OTFDM waveform offers low PAPR. In an embodiment, the OTFDM waveform or symbol is generated by performing spreading operation on the input bit sequence, the spreading helps in reducing the other user interface, increases user multiplexing ability, increases SINR and offers low PAPR. The spectrum shaping of excess BW reduces the PAPR and increases the overall transmission power.

In an embodiment, the OTFDM waveform generating unit comprises the following operations:
A. A DFT precoding is applied on the mapped sequence x′ (n) using a DFT of size L to obtain a precoded sequence X(k).

$$X ( k ) = \frac{1}{\sqrt{M}} {\sum }_{n = 0}^{L - 1} {x}^{′} ( n ) {e}^{- \frac{j 2 π kn}{L}}$$

B. Spectrum extension: The precoded sequence X(k) is equipped with the excess bandwidth, where the initial d/2 and trailing d/2 samples of the precoded sequence X(k) are copied to the end and start of X(k) respectively as prefix and postfix. Here d is the spectrum extension factor. This results in an OTFDM symbol of size L+d, which can be represented as,

$${X}_{exs} ( k ) = X ( ( k - \frac{d}{2} ) mod L )$$

$$Or$$

$${X}_{exs} ( k ) = X ( ( k - {k}^{′} ) mod L )$$

Where, k=0, 1, . . . , L+d−1. In an embodiment, the excess bandwidth (or excess subcarriers) used may be arbitrarily high and may be more than L subcarriers. k′ is an arbitrary value which may configure spectrum extension. For example, if k′ is d/2, where d is the extension factor, the spectrum extension is performed on both the ends of the precoded sequence, if k′ is zero, the extension is only to the right side of the precoded sequence. Similarly, when k′ is −L, the extension is completely on the left side to the precoded sequence.

The additional bandwidth that needs to be used for spectrum extension is indicated to a user equipment (UE) by a base station (BS). The BS, also referred as gNB, may indicate either extension on one side of the allocated bandwidth or two sides of the allocated bandwidth in steps of half PRB or one PRB or arbitrary number of subcarriers. The signaling of the excess bandwidth may be done as a part of resource allocation. The bandwidth extension on either side of the allocated bandwidth may be almost equal such that the spectrum shaping filter can be symmetric. The spectrum extension may be asymmetric also, which means, the additional bandwidth on each side of the allocated bandwidth may be of different sizes including the case where excess BW is added on only one side

Alternately the BS or the gNB may indicate the user with 2 parameters i.e. usable BW where data is allocated and excess BW where shaping is allowed. A scheduler in the BS may take care of these 2 parameters per UE as part of the entire scheduling operations. The excess BW when symmetric can be assumed to have equal guard subcarriers on either side of the allocated spectrum. However, for asymmetric cases, an additional parameter which indicates the start location of the usable BW can be indicated between UE and gNB. The spectrum extension factor depends on channel properties, allocation size, modulation order, L-length sequence type. Pi/2-BPSK modulated sequence is a special case, where spectrum extension may not be needed.
C. Spectrum shaping: The spectrum shaping is performed on the spectrum extended sequence by multiplying it with the frequency response of spectrum shaping filter. The spectrum shaped data can be represented as:

$${X}_{ss} ( k ) = W ( k ) {X}_{exs} ( k )$$

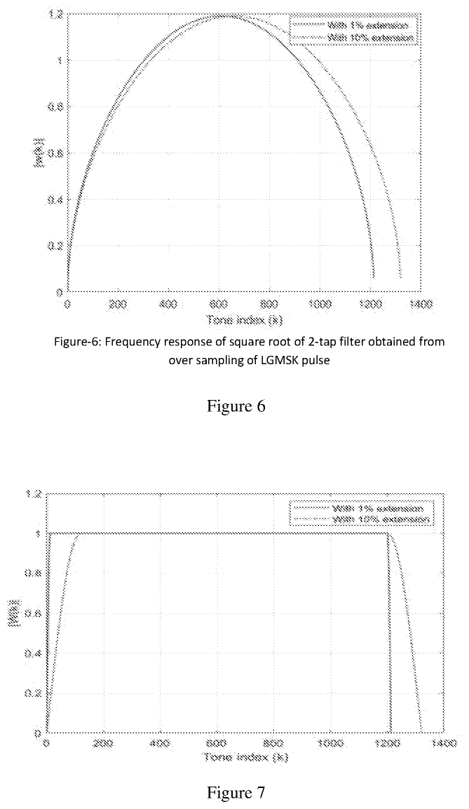

The filter W(k) can be frequency response of square root raise cosine, raised cosine, Hanning. Blackman or Hamming windows, or the filter can be an oversampled Linearized Gaussian Minimal Shifting Keying (LGMSK) pulse. Otherwise, filter W(k) can be the square root of the frequency response of the above-mentioned filters. The frequency response of some of the spectrum shaping filters are shown in FIGS. 3, 4, 5, and square root of the frequency response of these filters are shown in FIGS. 6, 7, 8. The spectrum shaping filter either be specified by the base station or can be unknown at the base station. The spectrum shaping filter may be RAN1 specified or specification transparent.

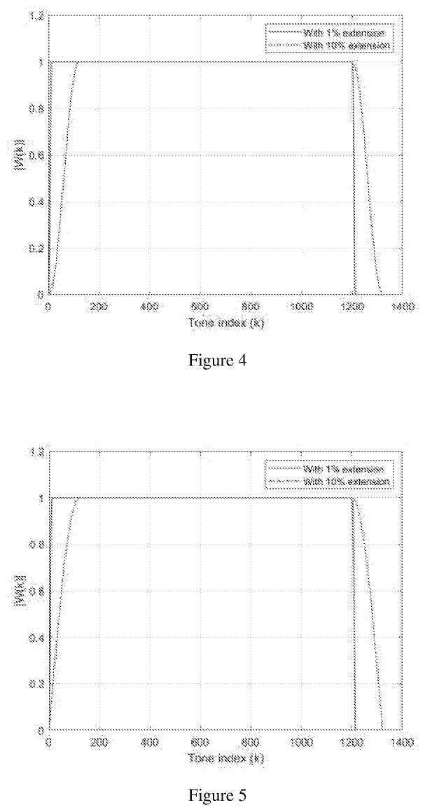

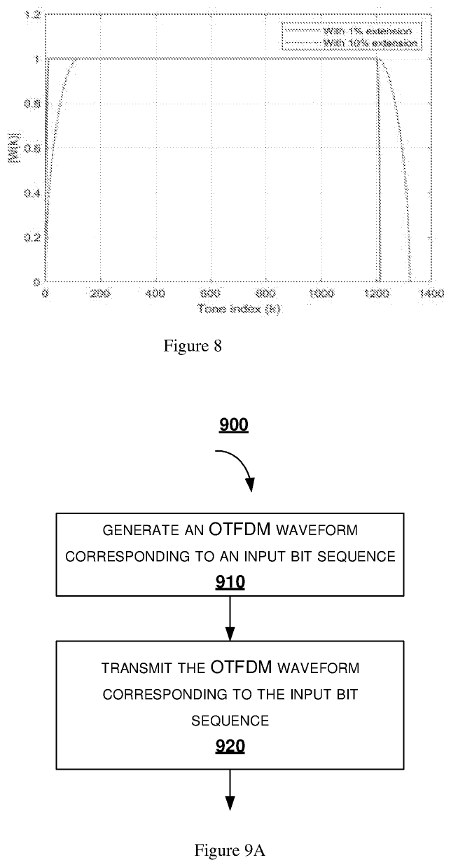

FIG. 3 shows a plot illustrating frequency response of 2-tap filter obtained from over sampling of L-GMSK pulse. FIG. 4 shows a plot illustrating frequency response of raised cosine pulse. FIG. 5 shows a plot illustrating frequency response of square root raised cosine pulse. FIG. 6 shows a plot illustrating the magnitude of square root of Frequency response of 2-tap filter obtained from over sampling of L-GMSK pulse. FIG. 7 shows a plot illustrating the magnitude of square root of frequency response of raised cosine pulse. FIG. 8 shows a plot illustrating the magnitude of square root of frequency response of square root raised cosine pulse.

When spectrum extension factor ‘d’ is zero, no spectrum extension is performed, for example, sequences like pi/2-BPSK. In this case, spectrum shaping can be performed either in time-domain by circular convolving the data-RS multiplexed symbol with impulse response of the spectrum shaping filter or in frequency domain, where the DFT-pre-coded symbol is simply multiplied with the frequency response of the spectrum shaping filter. The spectrum shaping help in reduction of PAPR.
D. Spectrum shaped data is mapped on to the subcarriers allocated to the user, followed by an IFFT of size N to generate a time domain symbol. The time domain symbol is appended with Cyclic Prefix (CP), and sent to the processing unit to obtain an OTFDM symbol. Overall transmitter structure with spectrum extension is shown in FIG. 1A, and block diagram for OTFDM symbol generation unit is presented in FIG. 1B.

In the processing unit, the generated OTFDM symbol after CP insertion may be processed with at least one of Bandwidth Part (BWP) specific phase rotation, Weighted overlap and add (WOLA), Up-conversion, Digital to analog conversion (DAC) to obtain the OTFDM waveform. FIG. 1C shows the block diagram for the processing unit.

In another embodiment of the present disclosure, the transmitter 100 is configured to generating and transmitting a plurality of waveforms. The transmitter 100 comprises mapping unit/sequence selection unit 104, an OTFDM symbol generating unit 108, and a plurality of antennas (not shown in the figures) for transmitting the generated OTFDM waveforms. The OTFDM symbol generating unit 108 is also referred as OTFDM symbol generator or symbol generator.

The transmitter generates an orthogonal time frequency division multiplexing (OTFDM) waveform corresponding to an input bit sequence associated with one of a plurality of transmitters. The input bit sequence of each of the plurality of transmitters is uniquely mapped to one of a plurality of OTFDM waveforms. Thereafter, the OTFDM waveform corresponding to the input bit sequence is transmitted using the associated antenna.

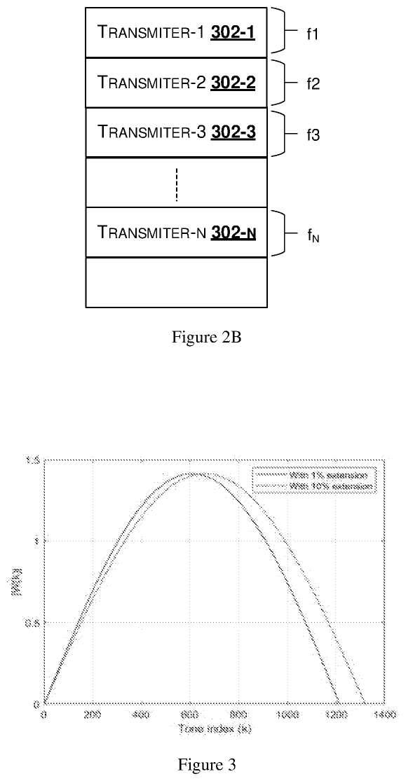

FIG. 2A shows a block diagram illustrating sequence mapping for an input bit sequence and generation of OTFDM waveform. The input sequence corresponding to control/user data is mapped to a sequence from a plurality of sequences. The mapped sequence is sent for OTFDM waveform generation.

As shown in the FIG. 2A, the input bit sequence 102 is mapped one of the plurality of sequences (Sequence-1 106-1, Sequence-2 106-2, Sequence-3 106-3, . . . , Sequence-N 106-N). Each of the sequences is of L-length. The value of L is one of 6, 12, 24, 36, 48 or any other value. The L-length sequence is selected based on at least one of a scrambling ID, symbol ID, slot number, and cell ID. The following tables i.e., Table-1, Table-2 and Table-3 shows an illustration of the input bit sequence (ACK, NACK and SR). In an embodiment 1-bit control transmits two OTFDM waveforms each representing either a 0 or 1.

TABLE 1

| ACK | NACK | SR | Sequence |
|---|---|---|---|
| 0 | 0 | 0 | Sequence-1 |
| 0 | 1 | 0 | Sequence-2 |
| 1 | 0 | 0 | Sequence-3 |
| 1 | 1 | 0 | Sequence-4 |
| 0 | 0 | 1 | Sequence-5 |
| 0 | 1 | 1 | Sequence-6 |
| 1 | 0 | 1 | Sequence-7 |
| 1 | 1 | 1 | Sequence-8 |

TABLE 2

| ACK | SR | Sequence |
|---|---|---|
| 0 | 0 | Sequence-1 |
| 0 | 1 | Sequence-2 |
| 1 | 0 | Sequence-3 |
| 1 | 1 | Sequence-4 |

TABLE 3

| ACK | NACK | Sequence |
|---|---|---|
| 0 | 0 | Sequence-1 |
| 0 | 1 | Sequence-2 |
| 1 | 0 | Sequence-3 |
| 1 | 1 | Sequence-4 |

Each of the input bit sequence is mapped to a L-length sequence, using which the OTFDM waveform generating unit generates a corresponding OTFDM waveform. This generation of the OTFDM waveform is performed by mapping the input bit sequence to one of a L-length sequence from a plurality of L-length sequences and generating an OTFDM waveform using the mapped L-length sequence. This is performed for each of the plurality of input bit sequences. The communication system as shown in FIG. 1A, transmits the generated OTFDM waveforms corresponding to each of the input bit sequences using the associated plurality of antennas. FIG. 2B shows a representation of the plurality of transmitters occupying distinct bandwidths in a given resource grid. As shown in the FIG. 2B, there are a plurality of antennas or transmitters for transmitting the associated OTFDM waveforms corresponding to the input bit sequences.

In an embodiment, the plurality of transmitters is frequency multiplexed, wherein each of the plurality of transmitters occupy orthogonal frequency subcarriers in the same OTFDM waveform. Also, the plurality of transmitters is time multiplexed, wherein each of the plurality of transmitters occupy distinct OTFDM waveforms. In an embodiment, the plurality of transmitters is associated with orthogonal sequences or spreading codes in the same time frequency resources. The plurality of transmitters belongs to a same cell or different cells. Further, the plurality of transmitters belongs to a same different antennas ports in an embodiment.

The L-length sequence of each transmitter is obtained from the same base sequence or different base sequence. In an embodiment, the L-length sequence of each transmitter is applied with one or more transmitter specific orthogonal cover codes. Each of the one or more transmitter specific code covers are orthogonal to each other. Each of the one or more transmitter specific code covers is one of a binary phase shift keying (BPSK) sequence, a Walsh Hadamard sequence, PN sequences, a DFT sequence, and a phase ramp sequence. The plurality of L-length sequences has low cross correlation.

FIG. 2B shows a representation of the plurality of transmitters occupying distinct bandwidths in a given resource grid. With this kind of mapping, the transmitters are separated in frequency.

Another embodiment of the present disclosure is generation of OTFDM waveforms for multiple transmitters at a given time instance. Input bit sequence of each transmitter is passed through sequence selection unit to obtain transmitter specific L-length mapped sequence. The transmitter specific L-length sequences may be obtained from the same or different base sequence. The transmitter specific L-length sequence may be a function of at least one of scrambling ID, symbol ID, slot number, and cell ID.

The transmitter specific L-length sequences of all the transmitters can be mapped to the same set of subcarriers or distinct subcarriers. If sequences are mapped to the same set of subcarriers, then these sequences are orthogonalized by means of exponential code covers. The mapped sequence of each transmitter is sent to OTFDM generation unit to generate transmitter specific OTFDM waveform.

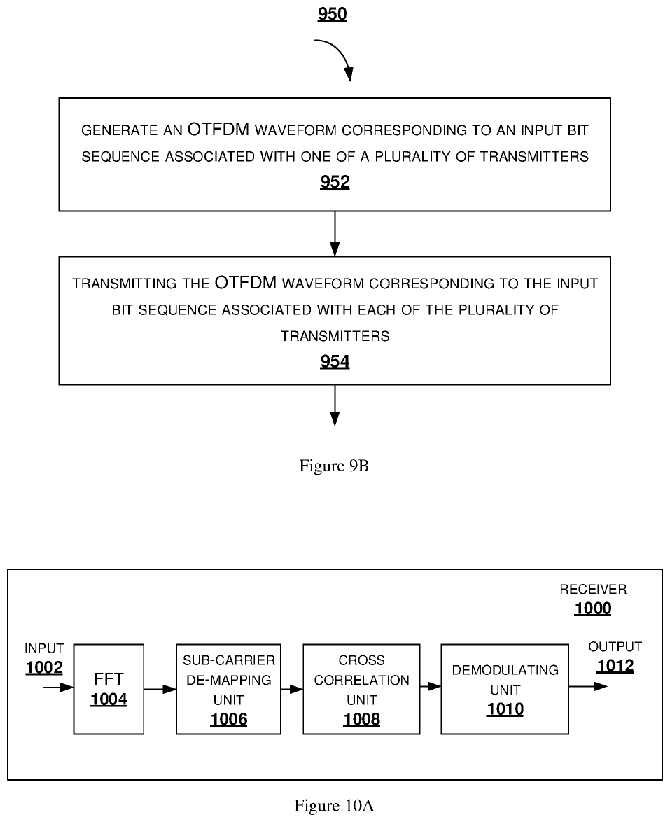

FIG. 9A shows a flowchart illustrating a method for transmitting a waveform in a communication network, in accordance with some embodiments of the present disclosure.

As illustrated in FIG. 9A, the method 900 comprises one or more blocks for transmitting a waveform. The method 900 may be described in the general context of computer executable instructions. Generally, computer executable instructions can include routines, programs, objects, components, data structures, procedures, modules, and functions, which perform functions or implement abstract data types.

The order in which the method 900 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 910, generating, by a transmitter, an orthogonal time frequency division multiplexing (OTFDM) waveform corresponding to an input bit sequence, wherein said input bit sequence is uniquely mapped to one of the plurality of OTFDM waveforms.

The mapping of the input bit sequence to one of a L-length sequence from a plurality of L-length sequences is performed by the sequence selection unit. The input bit sequence comprises one or more bits. The input bit sequence is at least one of ACK, NACK and SR. The output of the sequence selection unit is referred to as mapped sequence or mapped L-length sequence or L-length sequence. In an embodiment, the L-length sequence is a complex sequence. Each of the plurality of L-length sequences is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence. The value of L is one of 6, 12, 24, 36, 48 or any other value. In an embodiment, the L-length sequence is selected based on at least one of a scrambling ID, symbol ID, slot number, and cell ID.

An OFTDM waveform is generated using the OTFDM symbol generating unit 108 generates using the mapped L-length sequence.

At block 920, transmitting the generated OTFDM waveform corresponding to the input bit sequence using one of the plurality of antennas of the transmitter.

FIG. 9B shows a flowchart illustrating a method for transmitting a waveform in a communication network, in accordance with another embodiments of the present disclosure.

As illustrated in FIG. 9B, the method 950 comprises one or more blocks for transmitting a waveform. The method 950 may be described in the general context of computer executable instructions. Generally, computer executable instructions can include routines, programs, objects, components, data structures, procedures, modules, and functions, which perform functions or implement abstract data types.

The order in which the method 950 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 952, generating, by plurality of transmitters, an orthogonal time frequency division multiplexing (OTFDM) waveform corresponding to an input bit sequence associated with one of a plurality of transmitters, wherein an input bit sequence of each of the plurality of transmitters is uniquely mapped to one of a plurality of OTFDM waveforms.

At block 954, transmitting, by the plurality of transmitters, the OTFDM waveform corresponding to the input bit sequence associated with each of the plurality of transmitters.

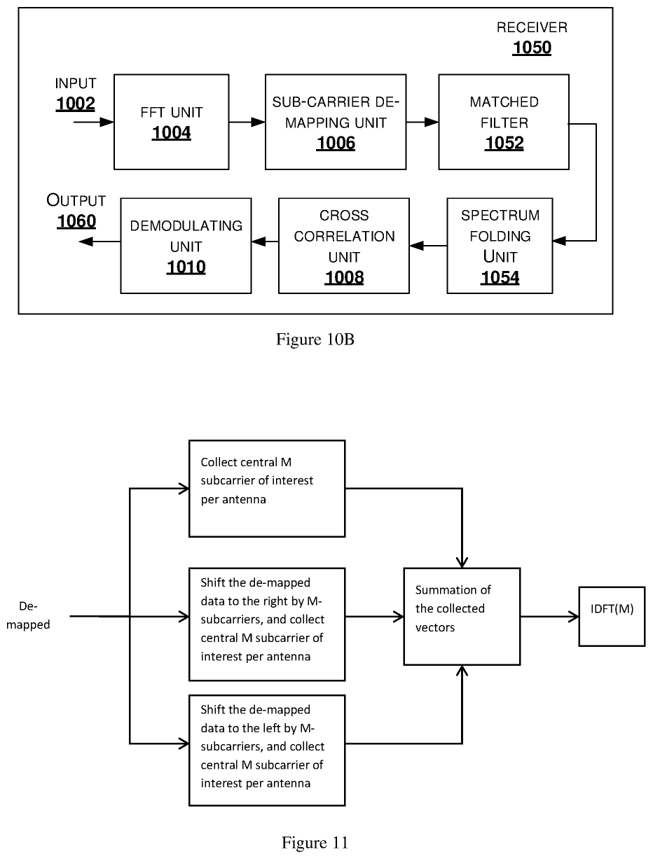

Embodiments of the present disclosure related to a receiver for receiving an OTFDM waveform. The FIGS. 10A and 10 B show the receiver lock diagrams.

FIG. 10A shows a block diagram of a receiver, in accordance with an embodiment of the present disclosure. As shown in the FIG. 10A, the receiver 1000 comprises Fast Fourier Transform (FFT) unit 1004, a subcarrier de-mapping unit 1006, a cross correlation unit 1008, and a demodulating unit 1010 to determine the received input waveform. In an embodiment, the received input waveform is an OTFDM waveform.

The FFT unit 1004 performs a Fast Fourier Transform (FFT) on a received waveform to obtain a transformed sequence. The de-mapping unit 1006 performs de-mapping operation on the transformed sequence using a plurality of sub-carriers to generate a de-mapped sequence. The cross correlation unit 1008 performs correlation operation on the de-mapped sequence using a plurality of sequences to obtain a correlation value, and compares the correlation value using a threshold to obtain best matched sequence. The plurality of sequences are real or complex-valued sequences. The demodulating unit 1010 performs demodulating the best matched sequence to obtain transmitted bit sequence.

In an embodiment, the receiver is configured with a spectrum folding unit (not shown in the figure) to perform a spectrum folding on the de-mapped sequence and obtain spectrum folded de-mapped sequence. The spectrum folded de-mapped sequence is correlated using a plurality of sequences to obtain a correlation value.

The received signal is first processed with front processing elements like ADC, CP removal and FFT. The allocated sub-carriers are de-mapped in the sub-carrier de-mapper, where L+d allocated sub-carriers are extracted from the FFT output. If spectrum shaping was performed at the transmitter and the spectrum shaping filter (W(k)) is known to the receiver, then extracted “L+d” subcarriers are multiplied with the same filter, i.e., W(k), before further processing. This helps in maximizing the receiver SNR like in matched filtering.

The spectrum shaping filter used by the transmitter and receiver is the same and is indicated (or pre-determined/priory agreed) between the transmitter and receiver. One example of such a filter is square root raised cosine pulse which is applied in the frequency domain (in both transmitter and receiver sides).

From L+d size de-mapped data Y(k), L samples can be obtained in two identical methods. In the first method, L samples are obtained from L+d samples by taking modified IDFT of size L, which can be given by the following expression.

$$\tilde{Y} ( k ) = \frac{1}{\sqrt{L}} {\sum }_{k = 0}^{L + d - 1} Y ( k ) {e}^{\frac{j 2 π ( k - \frac{d}{2} ) n}{L}}$$

The second method, which is equivalent to the above expression involves the following steps.
From the de-mapped data Y(k), central L-subcarriers are collected and labelled as Y₁(k).
The de-mapped data is left shifted by L-subcarriers to collect central L-subcarriers which is labelled as Y₂(k).
The de-mapped data is right shifted by L-subcarriers to collect central L-subcarriers which is labelled as Y₃(k).

Effective received data of size L is obtained by adding all the above collected data. The effective data can be given by

$$\tilde{Y} ( k ) = {Y}_{1} ( k ) + {Y}_{2} ( k ) + {Y}_{3} ( k )$$

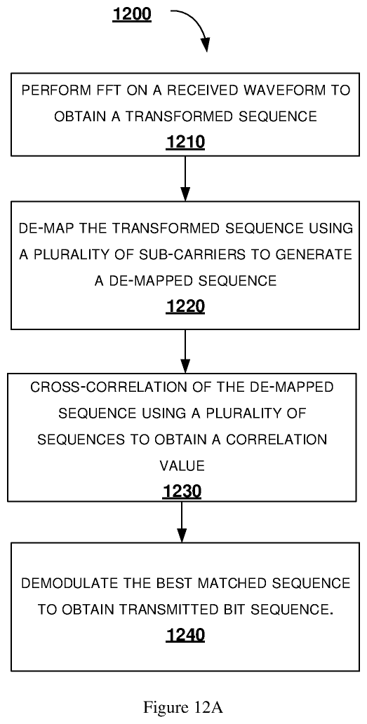

This procedure is encapsulated in the FIG. 11. In cases where the excess number of subcarriers is more than L, additional circularly shifted components (2L, 3L etc.) will be included in the above expression.

The L length sequence obtained from the above procedure is cross correlated with the possible reference sequences (known) at the receiver. The cross-correlation output for each of the reference sequences is compared with a defined threshold. From all the sequences which have got the cross correlation value more than threshold, one sequence with the highest cross-correlation value is identified. The input bits corresponding to the identified sequence are decoded.

The cross correlation of the received sequence with possible reference sequences at the receiver may also be performed in time domain by taking an IDFT of size L+d on the matched filter output or may be performed by taking an IDFT of size L on the output of spectrum folding, where, the L subcarriers from L+d can be from the beginning or the last L subcarriers, or the central L subcarriers, or any L subcarriers from L+d subcarriers.

The receiver architecture for the receiver without any receiver filtering is as shown in FIG. 10A, and the figure for the receiver block diagram with receiver filtering is shown in FIG. 10B.

As shown in the FIG. 10B, the receiver 1050 comprises Fast Fourier Transform (FFT) unit 1004, a subcarrier de-mapping unit 1006, a matched filter 1052, a spectrum folding unit 1054, a cross correlation unit 1008, and a demodulating unit 1010 to determine the received input waveform. In an embodiment, the received input waveform is an OTFDM waveform.

The FFT unit 1004 performs a Fast Fourier Transform (FFT) on a received waveform to obtain a transformed sequence. The de-mapping unit 1006 performs de-mapping operation on the transformed sequence using a plurality of sub-carriers to generate a de-mapped sequence. The matched filter 1052 and the spectrum folding unit 1054 performs filtering and spectrum folding operations on the de-mapped sequence to obtain a filtered, spectrum folded de-mapped sequence.

The cross correlation unit 1008 performs correlation operation on the filtered, spectrum folded de-mapped sequence using a plurality of sequences to obtain a correlation value, and compares the correlation value using a threshold to obtain best matched sequence. The demodulating unit 1010 performs demodulating the best matched sequence to obtain transmitted bit sequence.

If spectrum extension is not performed at the transmitter, the De-mapped sequence of size L is matched with the transmit spectrum shaping filter if it is known at the receiver. The matched filter output is used to correlate with the sequence known at the receiver to detect the transmit sequence to which transmit bits are mapped. Once the transmit sequence is detected at the receiver using correlation, transmit bits can be detected.

In another embodiment for the receiver, L sub-carriers are selected from the L+d de-mapped sub-carriers to decode the transmitted input sequence. These L sub-carriers will be used for correlation with the sequences generated at the receiver to detect the transmit sequence. The L subcarriers from L+d can be from the beginning or the end or the central L subcarriers, or any L subcarriers from L+d subcarriers. The L subcarriers are correlated with all the possible reference sequence (known) at the receiver. The correlation output for each sequence is compared to a threshold, and the one sequence with the highest correlated value will be identified as the transmitted sequence. The identified transmitted sequence is eventually used for transmit bits' detection.

In the following embodiments we describe a method of design of spreading sequences that can be mapped to transmit bits.

In this method a base sequence that is obtained by taking a BPSK sequence that goes through pi/2 constellation rotation. Various cyclic shifts of the base sequence may be used as inputs. The base sequences and the number of cyclic shifts that result in low PAPR and low correlation among the base sequences and zero correlation among the cyclic shifts of a base sequence may be obtained through a computer search. The base sequences are optimized such that the generated waveforms have optimized or low PAPR. The time domain computer generated BPSK base sequences are illustrated in the below Table 1.

TABLE 4

| S. No. | Sequence | | | | | | | | | | | |
|---|---|---|---|---|---|---|---|---|---|---|---|---|
| 1 | 1 | −1 | −1 | −1 | −1 | 1 | −1 | 1 | −1 | −1 | 1 | 1 |
| 2 | −1 | −1 | −1 | −1 | −1 | 1 | 1 | −1 | −1 | 1 | −1 | 1 |
| 3 | −1 | −1 | −1 | −1 | 1 | −1 | −1 | 1 | 1 | 1 | −1 | 1 |
| 4 | 1 | −1 | −1 | −1 | 1 | −1 | 1 | 1 | 1 | −1 | −1 | 1 |
| 5 | −1 | −1 | −1 | −1 | 1 | 1 | −1 | 1 | −1 | −1 | −1 | 1 |
| 6 | 1 | −1 | −1 | 1 | −1 | −1 | −1 | 1 | −1 | 1 | 1 | −1 |
| 7 | 1 | −1 | −1 | 1 | 1 | −1 | 1 | 1 | 1 | 1 | −1 | 1 |
| 8 | 1 | 1 | −1 | −1 | −1 | 1 | −1 | −1 | −1 | −1 | 1 | 1 |
| 9 | −1 | 1 | −1 | 1 | 1 | −1 | −1 | −1 | −1 | 1 | −1 | −1 |
| 10 | −1 | 1 | 1 | −1 | 1 | −1 | 1 | 1 | 1 | 1 | 1 | −1 |
| 11 | −1 | 1 | 1 | 1 | −1 | 1 | −1 | −1 | −1 | −1 | 1 | −1 |
| 12 | 1 | −1 | 1 | 1 | −1 | −1 | 1 | 1 | 1 | 1 | 1 | −1 |
| 13 | −1 | −1 | −1 | −1 | 1 | −1 | −1 | −1 | 1 | −1 | 1 | 1 |
| 14 | 1 | −1 | −1 | −1 | 1 | 1 | −1 | −1 | 1 | −1 | 1 | −1 |
| 15 | 1 | −1 | −1 | 1 | −1 | −1 | −1 | −1 | 1 | 1 | −1 | 1 |
| 16 | −1 | −1 | −1 | 1 | −1 | −1 | 1 | 1 | 1 | −1 | 1 | −1 |
| 17 | 1 | −1 | −1 | 1 | −1 | 1 | 1 | 1 | 1 | −1 | 1 | 1 |
| 18 | −1 | −1 | 1 | −1 | −1 | −1 | −1 | 1 | −1 | 1 | 1 | 1 |
| 19 | −1 | −1 | 1 | −1 | 1 | 1 | −1 | −1 | −1 | −1 | 1 | −1 |
| 20 | −1 | −1 | 1 | 1 | −1 | 1 | −1 | −1 | −1 | 1 | −1 | −1 |
| 21 | 1 | 1 | −1 | −1 | 1 | 1 | −1 | −1 | −1 | −1 | −1 | 1 |
| 22 | 1 | −1 | 1 | −1 | −1 | −1 | 1 | 1 | −1 | 1 | 1 | 1 |
| 23 | 1 | 1 | −1 | 1 | −1 | 1 | 1 | 1 | 1 | 1 | −1 | −1 |
| 24 | 1 | 1 | 1 | 1 | 1 | −1 | 1 | −1 | 1 | 1 | −1 | −1 |
| 25 | 1 | −1 | −1 | −1 | 1 | −1 | 1 | −1 | −1 | 1 | 1 | −1 |
| 26 | −1 | −1 | −1 | 1 | −1 | 1 | 1 | −1 | −1 | −1 | −1 | 1 |
| 27 | 1 | −1 | −1 | 1 | −1 | 1 | 1 | 1 | −1 | −1 | 1 | −1 |
| 28 | 1 | −1 | −1 | 1 | 1 | −1 | −1 | 1 | −1 | 1 | −1 | −1 |
| 29 | 1 | −1 | −1 | 1 | 1 | −1 | 1 | −1 | −1 | −1 | 1 | −1 |
| 30 | 1 | −1 | 1 | −1 | −1 | 1 | 1 | 1 | −1 | 1 | −1 | −1 |

In an embodiment for using 1 or 2 bit UCI (user control information) transmission, UCI is mapped to BPSK or QPSK symbol and the symbol is mapped to a sequence code selected from Table-4. The index of the code may be signalled by the base station as a circular shift of a base pi/2 BPSK sequence or a ZC sequence.

The sequence may also be allocated from Table-4 and may be signalled by the base station as a circular shift of a base pi/2 BPSK sequence or a ZC sequence.

The data/control may be spreading using Walsh-Hadamard sequences of a given size or orthogonal DFT sequences.

In an embodiment, the spectrally extended DFT output sequence may be mapped to more than one symbol. In this case, the spreading sequence applied in each OFDM symbol may be distinct and is a function of at least one of OFDM symbol index and slot index.

In an embodiment, the transmission includes more than one OFDM symbol and the sequence in each symbol is selected as a function of at least one of OFDM symbol index and slot index.

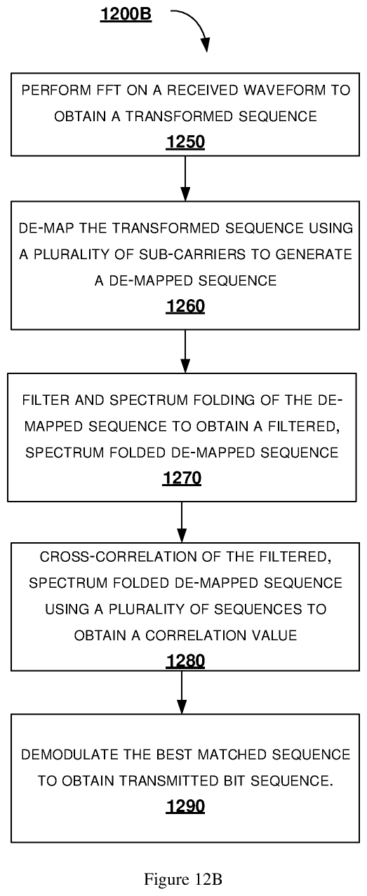

FIG. 12A shows a flowchart illustrating a method for receiving a waveform in a communication network, in accordance with some embodiments of the present disclosure.

As illustrated in FIG. 12A, the method 1200 comprises one or more blocks for receiving a waveform. The method 1200 may be described in the general context of computer executable instructions. Generally, computer executable instructions can include routines, programs, objects, components, data structures, procedures, modules, and functions, which perform functions or implement abstract data types.

The order in which the method 1200 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 1210, performing, by the receiver, a Fast Fourier Transform (FFT) on a received waveform to obtain a transformed sequence.

At block 1220, performing de-mapping operation, by the receiver, on the transformed sequence using a plurality of sub-carriers to generate a de-mapped sequence.

At block 1230, performing correlation operation on the de-mapped sequence using a plurality of sequences to obtain a correlation value. Thereafter, comparing the correlation value using a threshold to obtain best matched sequence.

At block 1240, demodulating, by the receiver, the best matched sequence to obtain transmitted bit sequence.

FIG. 12B shows a flowchart illustrating a method for receiving a waveform in a communication network, in accordance with another embodiments of the present disclosure.

As illustrated in FIG. 12B, the method 1200B comprises one or more blocks for receiving a waveform. The method 1200B may be described in the general context of computer executable instructions. Generally, computer executable instructions can include routines, programs, objects, components, data structures, procedures, modules, and functions, which perform functions or implement abstract data types.

The order in which the method 1200B is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 1250, performing, by the receiver, a Fast Fourier Transform (FFT) on a received waveform to obtain a transformed sequence.

At block 1260, performing de-mapping operation, by the receiver, on the transformed sequence using a plurality of sub-carriers to generate a de-mapped sequence.

At block 1270, filtering and spectrum folding operations are performed on the de-mapped sequence to obtain a filtered, spectrum folded de-mapped sequence.

At block 1280, performing correlation operation on the filtered, spectrum folded de-mapped sequence using a plurality of sequences to obtain a correlation value. Thereafter, comparing the correlation value using a threshold to obtain best matched sequence.

At block 1290, demodulating, by the receiver, the best matched sequence to obtain transmitted bit sequence.

Further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for transmitting a waveform, comprising:
generating, by a transmitter, an orthogonal time frequency division multiplexing (OTFDM) waveform corresponding to an input bit sequence, wherein said input bit sequence is uniquely mapped to one of the plurality of OTFDM waveforms; and
transmitting, by the transmitter, the OTFDM waveform corresponding to the input bit sequence.

2. The method as claimed in claim 1, wherein the input bit sequence is at least one of ACK, NACK and SR.

3. The method as claimed in claim 1, wherein the input bit sequence comprises one or more bits.

4. The method as claimed in claim 1, wherein the mapping of input bit sequence to one of the plurality of OTFDM waveforms comprises:
mapping the input bit sequence to one of a L-length sequence from a plurality of L-length sequences; and
generating an OTFDM waveform using the mapped L-length sequence.

5. The method as claimed in claim 5, wherein each of the plurality of L-length sequences is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence.

6. The method as claimed in claim 5, wherein the value of L is one of 6, 12, 24, 36, 48 or any other value.

7. The method as claimed in claim 5, wherein the L-length sequence is selected based on at least one of a scrambling ID, symbol ID, slot number, and cell ID.

8. The method as claimed in claim 1, wherein generating the OTFDM waveform corresponding to the input bit sequence comprises:
transforming the L-length sequence using a Discrete Fourier Transform (DFT) to generate a transformed sequence;
performing padding operation by prefixing the transformed sequence with a first predefined number (NI) of subcarriers and post-fixing the transformed sequence with a second predefined number (N2) of subcarriers to obtain an extended bandwidth transformed sequence;
subcarrier mapping the extended bandwidth transformed sequence with at least one of localized and distributed subcarriers to generate a subcarrier mapped sequence;
shaping the subcarrier mapped sequence using a filter to obtain a shaped subcarrier mapped sequence;
performing an Inverse Fast Fourier Transform (IFFT) on the shaped subcarrier mapped sequence to produce a time domain sequence; and
processing the time domain sequence to generate the OTFDM waveform.

9. The method as claimed in claim 8, wherein value of the N1 is at least zero, and value of the N2 is at least zero.

10. The method as claimed in claim 8, wherein the value of N1 and N2 depends on one of channel conditions, modulation order, coding rate, impulse response of spectrum shaping filter.

11. The method as claimed in claim 8, wherein a length of the excess subcarriers added to the transformed sequence is explicitly indicated by one of a transmitter to a receiver and a receiver to a transmitter, said explicit indication is one of a function of allocation to the receiver and a plurality of predefined values at the transmitter.

12. The method as claimed in claim 8, wherein a length of the excess subcarriers added to the transformed sequence is explicitly indicated by a transmitter to a receiver, said explicit indication is one of a function of number of subcarrier allocation and a plurality of predefined values at the transmitter and power capability of the transmitter.

13. The method as claimed in claim 8, wherein processing the time domain sequence to generate an OTFDM waveform comprises performing at least one of addition of symbol cyclic prefix, addition of symbol cyclic suffix, windowing, weighted with overlap and add operation (WOLA), and frequency shifting on the time domain waveform, to generate the OTFDM waveform.

14. A method for transmitting a plurality of waveforms, comprising:
generating, by plurality of transmitters, an orthogonal time frequency division multiplexing (OTFDM) waveform corresponding to an input bit sequence associated with one of a plurality of transmitters, wherein an input bit sequence of each of the plurality of transmitters is uniquely mapped to one of a plurality of OTFDM waveforms; and
transmitting, by the plurality of transmitters, the OTFDM waveform corresponding to the input bit sequence associated with each of the plurality of transmitters.

15. The method as claimed in claim 14, wherein the plurality of transmitters are frequency multiplexed, wherein each of the plurality of transmitters occupy orthogonal frequency subcarriers in the same OTFDM waveform.

16. The method as claimed in claim 14, wherein the plurality of transmitters are time multiplexed, wherein each of the plurality of transmitters occupy distinct OTFDM waveforms.

17. The method as claimed in claim 14, wherein the plurality of transmitters are associated with orthogonal sequences or spreading codes in the same time frequency resources.

18. The method as claimed in claim 14, wherein the plurality of transmitters belongs to a same cell or different cells.

19. The method as claimed in claim 14, wherein the plurality of transmitters belongs to a same different antennas ports.

20. The method as claimed in claim 14, wherein the input bit sequence is at least one of ACK, NACK and SR.

21-33. (canceled)
